(19) United States
(12) Patent Application Publication
(10) Pub. No.: US 2025/0096492 A1
(43) Pub. Date: Mar. 20, 2025

(54) CONNECTOR ASSEMBLY

(71) Applicant: JAPAN AVIATION ELECTRONICS INDUSTRY, LIMITED, Tokyo (JP)

(72) Inventors: Atsushi KOBAYASHI, Tokyo (JP); Takashi OMODACHI, Tokyo (JP)

(73) Assignee: JAPAN AVIATION ELECTRONICS INDUSTRY, LIMITED, Tokyo (JP)

(21) Appl. No.: 18/828,246

(22) Filed: Sep. 9, 2024

Related U.S. Application Data
(60) Provisional application No. 63/538,361, filed on Sep. 14, 2023.

(30) Foreign Application Priority Data
Jul. 29, 2024 (JP) 2024-122632

(51) Int. Cl. H01R 12/71; H01R 13/11

(52) U.S. Cl. CPC H01R 12/716; H01R 13/11

(57) ABSTRACT

A connector assembly comprises a plug connector and a receptacle connector. The receptacle connector includes a receptacle insulator and a row of receptacle terminals. Each of the receptacle terminals has a main contact point, a support contact point, and a resilient portion. The plug connector includes a plug insulator and a row of plug terminals. Each of the plug terminals has a main contact portion, a support contact portion, an insertion end portion, a contact difference and an additional contact difference. Under a mated state where the plug connector and the receptacle connector are mated with each other, the main contact points are in contact with the main contact portions while the support contact points are in contact with the support contact portions. The main contact portion of each of the plug terminals is flush with the support contact portion of the plug terminal adjacent thereto.

### CROSS REFERENCE TO RELATED APPLICATIONS

The present application is based on and claims the benefit of U.S. Provisional Patent Application No. 63/538,361, filed on Sep. 14, 2023, which is incorporated herein by reference in its entirety, and also claims priority under 35 U.S.C. § 119 to Japanese Patent Application No. JP2024-122632 filed Jul. 29, 2024, the contents of which are incorporated herein in their entirety by reference.

### BACKGROUND OF THE INVENTION

This invention relates to a connector assembly comprising a plug connector and a receptacle connector which are mateable with each other.

Referring to FIG. 20, JP-A 2015-8055 (Patent Document 1) discloses a connector 900, or a connector assembly 900. Specifically, the connector assembly 900 comprises a header 910, or a plug connector 910, and a socket 920, or a receptacle connector 920, which are mateable with each other. The receptacle connector 920 includes a socket housing 922, or a receptacle insulator 922, and socket-side terminals 924, or receptacle terminals 924. Specifically, the receptacle terminals 924 are held by the receptacle insulator 922 and form a row. The receptacle terminals 924 are staggered in arrangement. Each of the receptacle terminals 924 has a socket-side main contact portion 9242, or a main contact point 9242, a side wall portion 9244, or a support contact point 9244, a resilient portion 9246 and a socket-side lock portion 9248. Specifically, the resilient portion 9246 connects between the main contact point 9242 and the support contact point 9244. As shown in FIG. 21, the plug connector 910 includes a header housing 912, or a plug insulator 912, and header-side terminals 914, or plug terminals 914. Specifically, the plug terminals 914 are held by the plug insulator 912 and from a row. The plug terminals 914 are staggered in arrangement. Each of the plug terminals 914 has a header-side main contact portion 9142, or a main contact portion 9142, a header-side contact portion 9144, or a support contact portion 9144, a coupling portion 9146, or an insertion end portion 9146, a header-side lock portion 9147, or a contact difference 9147, and an engaging recess 9148. Referring to FIGS. 21 and 22, the receptacle terminals 924 correspond to the plug terminals 914, respectively. The insertion end portion 9146 of each of the plug terminals 914 is inserted between the main contact point 9242 and the support contact point 9244 of the receptacle terminal 924 corresponding thereto, when the plug connector 910 is mated with the receptacle connector 920. Under a mated state where the plug connector 910 and the receptacle connector 920 are mated with each other, the main contact points 9242 are in contact with the main contact portions 9142 while the support contact points 9244 are in contact with the support contact portions 9144.

Referring to FIG. 20, when the plug connector 910 is mated with the receptacle connector 920, the main contact point 9242 of the receptacle terminal 924 is snapped into the engaging recess 9148 of the plug terminal 914 while the socket-side lock portion 9248 of the receptacle terminal 924 is snap-engaged with the contact difference 9147 of the plug terminal 914. Accordingly, the plug connector 910 and the receptacle connector 920 are snap-mated with each other. In other words, when the plug connector 910 and the receptacle connector 920 are mated with each other, a user can get a click feeling or tactile signal while the mating of the plug connector 910 with the receptacle connector 920 is locked.

A connector assembly such as the connector assembly 900 of Patent Document 1 is required to have a reduced manufacturing cost.

### SUMMARY OF THE INVENTION

It is therefore an object of the present invention to provide a connector assembly comprising a plug connector and a receptacle connector, wherein: plug terminals of the plug connector are staggered in arrangement; receptacle terminals of the receptacle connector are staggered in arrangement; a user can get a click feeling or tactile signal upon mating of the plug connector with the receptacle connector; and the connector assembly can have a reduced manufacturing cost.

One aspect of the present invention provides a connector assembly comprising a plug connector and a receptacle connector which are mateable with each other. The receptacle connector includes a receptacle insulator and a row of receptacle terminals held by the receptacle insulator. The receptacle terminals are staggered in arrangement. Each of the receptacle terminals has a main contact point, a support contact point, and a resilient portion, wherein the resilient portion connects between the support contact point and the main contact point. For each of the receptacle terminals, the main contact point and the support contact point are apart from each other in a width direction. The plug connector includes a plug insulator and a row of plug terminals held by the plug insulator. The plug terminals are staggered in arrangement. Each of the plug terminals has a main contact portion, a support contact portion, an insertion end portion, a contact difference and an additional contact difference. For each of the plug terminals, the main contact portion and the support contact portion are apart from each other in the width direction. For each of the plug terminals, a part of the insertion end portion is larger than a minimum distance between the main contact portion and the support contact portion in the width direction. The contact difference is positioned at a boundary between the insertion end portion and the support contact portion. The additional contact difference is positioned at a boundary between the insertion end portion and the main contact portion. The receptacle terminals correspond to the plug terminals, respectively. The insertion end portion of each of the plug terminals is inserted between the main contact point and the support contact point of the receptacle terminal corresponding thereto, when the plug connector is mated with the receptacle connector. Under a mated state where the plug connector and the receptacle connector are mated with each other, the main contact points are in contact with the main contact portions while the support contact points are in contact with the support contact portions. The main contact portion of each of the plug terminals is flush with the support contact portion of the plug terminal adjacent thereto.

The connector assembly of the present invention is configured so that the main contact portion of each of the plug terminals is flush with the support contact portion of the plug terminal adjacent thereto. This enables a metal mold, which is used upon insert-molding of the plug connector of the connector assembly of the present invention, to have a simple planar surface by which a manufacturer is configured to simultaneously press the main contact portion and the support contact portion. Accordingly, the metal mold can have a simple shape. In other words, the connector assembly of the present invention can have a reduced manufacturing cost.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a side view showing a connector assembly according to an embodiment of the present invention. In the figure, a plug connector and a receptacle connector are in an unmated state where the plug connector is unmated with the receptacle connector.

FIG. 2 is a cross-sectional view showing the connector assembly of FIG. 1, taken along line A-A.

FIG. 3 is a cross-sectional view showing the connector assembly of FIG. 1, taken along line B-B.

FIG. 4 is a perspective view showing the connector assembly of FIG. 1. In the figure, the plug connector and the receptacle connector are in a mated state where the plug connector and the receptacle connector are mated with each other.

FIG. 5 is a side view showing the connector assembly of FIG. 4.

FIG. 6 is a cross-sectional view showing the connector assembly of FIG. 5, taken along line C-C.

FIG. 7 is a cross-sectional view showing the connector assembly of FIG. 5, taken along line D-D.

FIG. 8 is a perspective view showing the plug connector which is included in the connector assembly of FIG. 4.

FIG. 9 is an enlarged, perspective view showing a part of the plug connector FIG. 8 which is enclosed by dashed-line E.

FIG. 10 is a top view showing the plug connector of FIG. 8.

FIG. 11 is a side view showing the plug connector of FIG. 8.

FIG. 12 is a bottom view showing the plug connector of FIG. 8.

FIG. 13 is a perspective view showing the receptacle connector which is included in the connector assembly of FIG. 4.

FIG. 14 is a top view showing the receptacle connector of FIG. 13.

FIG. 15 is a side view showing the receptacle connector of FIG. 13.

FIG. 16 is a bottom view showing the receptacle connector of FIG. 13.

FIG. 17 is an enlarged, perspective view showing a part of a plug connector which is included in a first modification of the connector assembly of FIG. 4.

FIG. 18 is an enlarged, perspective view showing a part of a plug connector which is included in a second modification of the connector assembly of FIG. 4.

FIG. 19 is an enlarged, perspective view showing a part of a plug connector which is included in a third modification of the connector assembly of FIG. 4.

FIG. 20 is a cross-sectional view showing a connector of Patent Document 1.

FIG. 21 is a perspective view showing a header which is included in the connector of FIG. 20.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

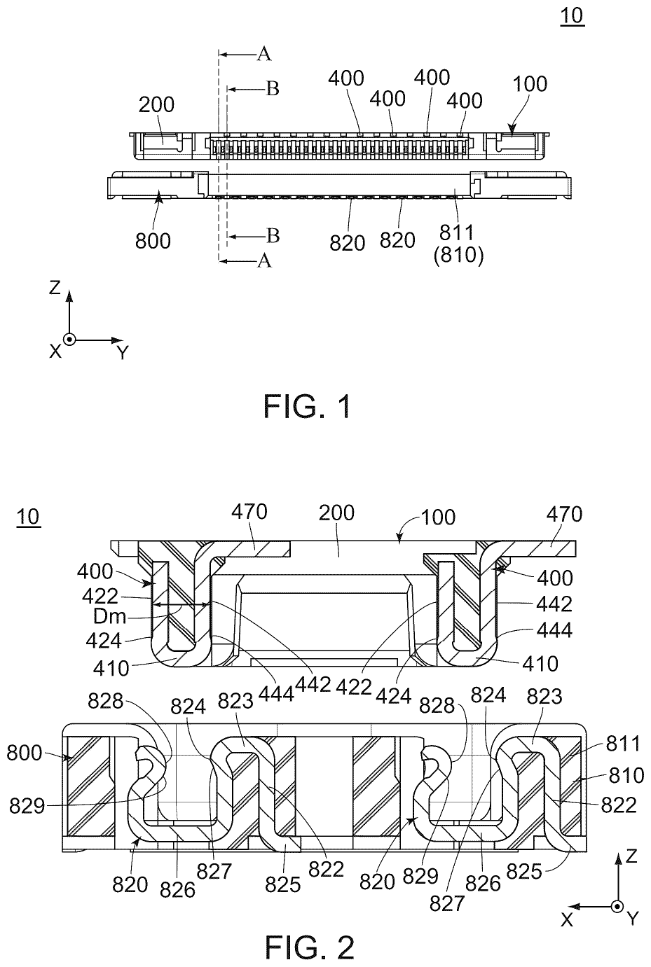

Referring to FIG. 1, a connector assembly 10 according to an embodiment of the present invention comprises a plug connector 100 and a receptacle connector 800. As shown in FIG. 4, the plug connector 100 and the receptacle connector 800 are mateable with each other.

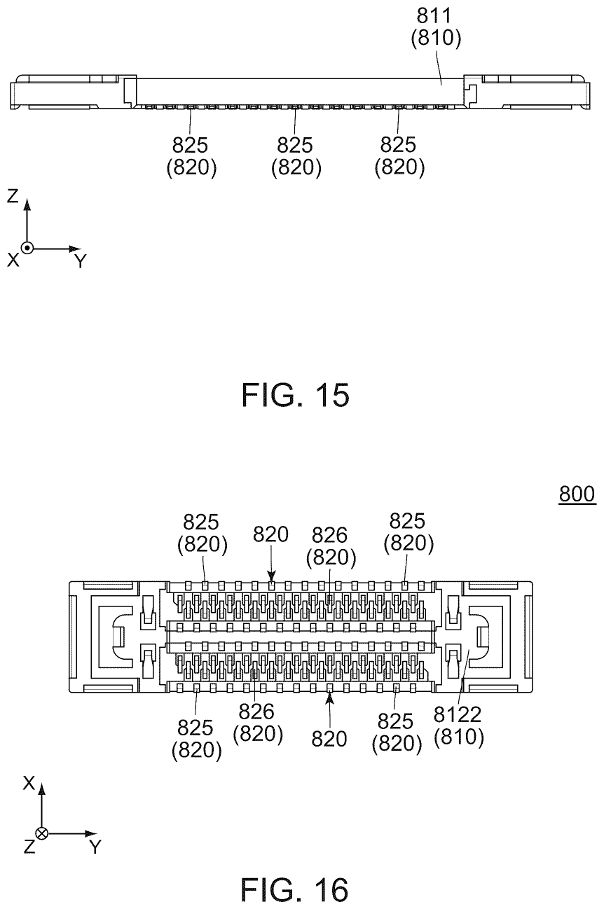

Referring to FIG. 15, the receptacle connector 800 of the present embodiment is mountable on a substrate (not shown) whose surface is formed with pads (not shown). As shown in FIG. 6, the receptacle connector 800 of the present embodiment is mateable with the plug connector 100 in an up-down direction. In the present embodiment, the up-down direction is a Z-direction. Specifically, it is assumed that upward is a positive Z-direction while downward is a negative Z-direction.

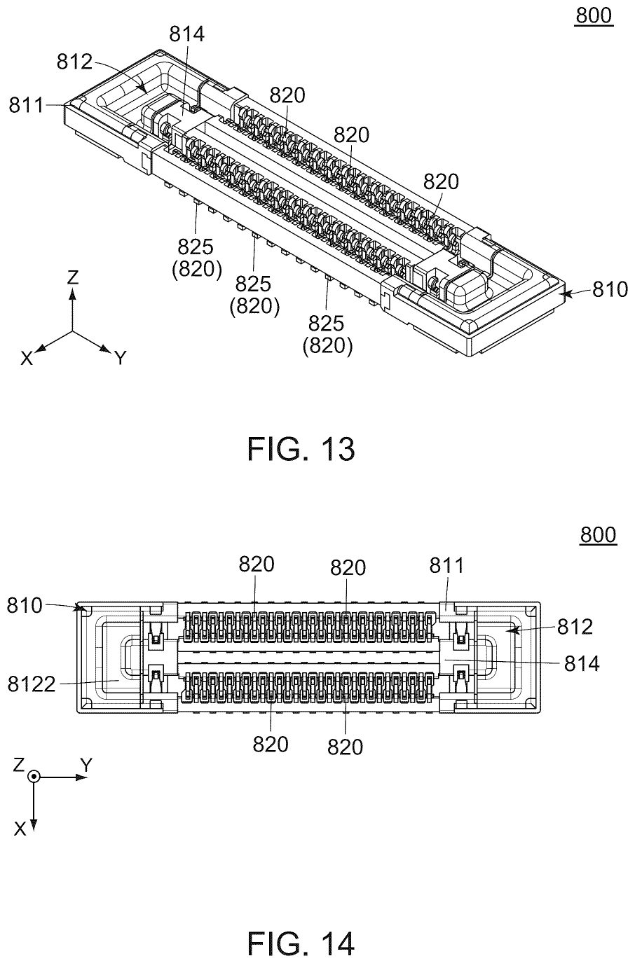

As shown in FIG. 13, the receptacle connector 800 of the present embodiment includes a receptacle insulator 810 and receptacle terminals 820.

Referring to FIG. 13, the receptacle insulator 810 of the present embodiment is made of insulator. The receptacle insulator 810 holds the receptacle terminals 820. The receptacle insulator 810 has a surrounding portion 811, a wall portion accommodating portion 812 and an island-like portion 814.

As shown in FIG. 13, the surrounding portion 811 of the present embodiment has a substantially rectangular tube shape extending in the up-down direction. The surrounding portion 811 defines outer ends of the receptacle insulator 810 in a width direction perpendicular to the up-down direction. In the present embodiment, the width direction is an X-direction. The width direction is also referred to as a front-rear direction. Specifically, it is assumed that forward is a positive X-direction while rearward is a negative X-direction. The surrounding portion 811 defines outer ends of the receptacle insulator 810 in a pitch direction perpendicular to both the up-down direction and the width direction. In the present embodiment, the pitch direction is a Y-direction.

As shown in FIG. 14, the wall portion accommodating portion 812 of the present embodiment is surrounded by the surrounding portion 811 in a plane perpendicular to the up-down direction. The wall portion accommodating portion 812 is a recess which is recessed downward in the up-down direction. Specifically, the wall portion accommodating portion 812 has a lower surface 8122. The lower surface 8122 defines a lower end of the wall portion accommodating portion 812 in the up-down direction.

Referring to FIG. 14, the island-like portion 814 of the present embodiment protrudes upward in the up-down direction from the lower surface 8122. The island-like portion 814 is surrounded by the wall portion accommodating portion 812 in a plane perpendicular to the up-down direction.

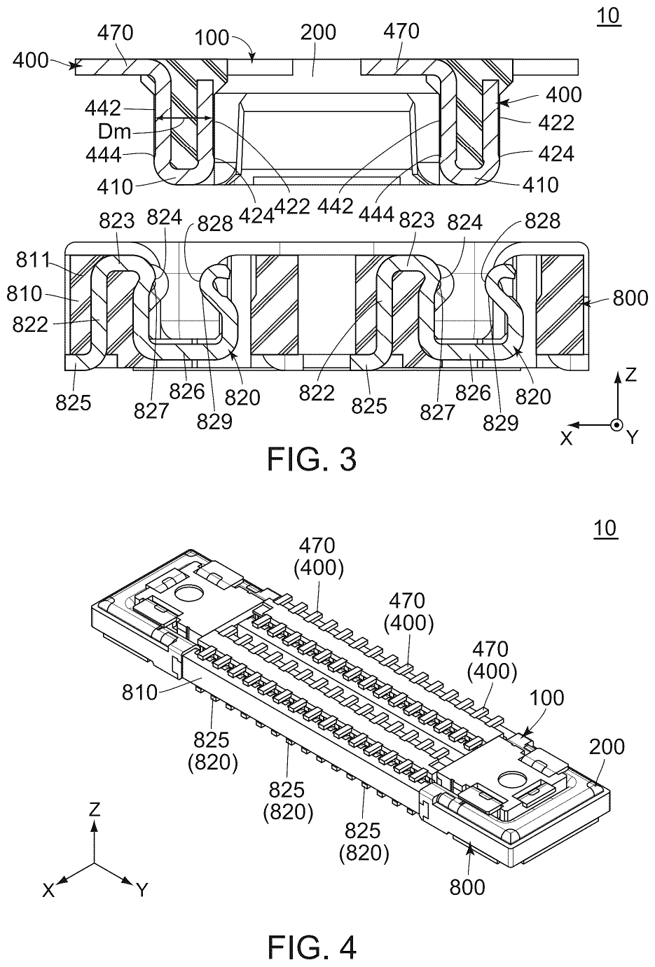

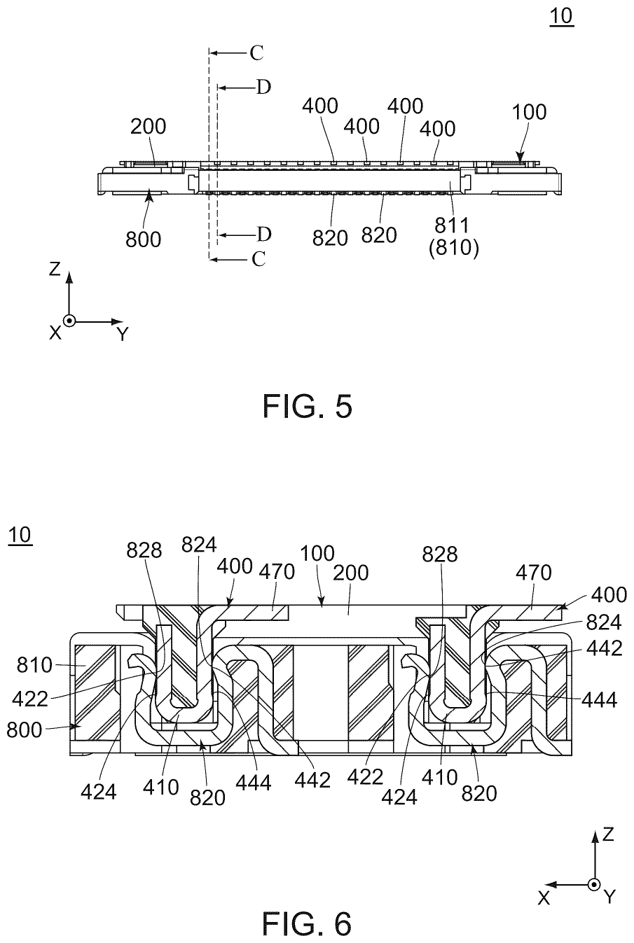

Referring to FIG. 2, each of the receptacle terminals 820 of the present embodiment is made of metal. Referring to FIGS. 2 and 3, the receptacle terminals 820 have shapes same as each other. The receptacle terminals 820 are held by the receptacle insulator 810. Specifically, the receptacle terminals 820 are partially embedded in and held by the receptacle insulator 810 via insert-molding. However, the present invention is not limited thereto. Specifically, the receptacle terminal 820 may be held by the receptacle insulator 810 by another method other than insert-molding.

As shown in FIG. 14, the receptacle terminals 820 are arranged in two rows, namely, a front row and a rear row, in the width direction. The receptacle terminals 820 of each row are arranged in the pitch direction. However, the present invention is not limited thereto. Specifically, the receptacle terminals 820 may be arranged in a row. In other words, the receptacle connector 800 should have a row of the receptacle terminals 820. The receptacle terminals 820 of one of the two rows correspond to the receptacle terminals 820, respectively, of a remaining one of the two rows. The receptacle terminals 820 are staggered in arrangement. More specifically, in each row, the receptacle terminals 820 are staggered in arrangement.

As shown in FIG. 2, each of the receptacle terminals 820 of the present embodiment has a main contact point 828, a support contact point 824 and a resilient portion 826.

As shown in FIG. 2, the main contact point 828 of the present embodiment is connected to the resilient portion 826. The main contact point 828 is supported by the resilient portion 826. The main contact point 828 of the receptacle terminal 820 of one of the two rows and the main contact point 828 of the corresponding receptacle terminal 820 of a remaining one of the two rows face orientations same as each other in the width direction. Referring to FIGS. 2 and 3, in neighboring two of the receptacle terminals 820 in the pitch direction, an orientation, which the main contact point 828 of one of the two receptacle terminals 820 faces in the width direction, is opposite to an orientation which the main contact point 828 of a remaining one of the two receptacle terminals 820 faces in the width direction.

As shown in FIG. 2, the support contact point 824 of the present embodiment is connected to the resilient portion 826. For each of the receptacle terminals 820, the main contact point 828 and the support contact point 824 are apart from each other in the width direction. For each of the receptacle terminals 820, the main contact point 828 and the support contact point 824 face each other in the width direction. The support contact point 824 of the receptacle terminal 820 of one of the two rows and the support contact point 824 of the corresponding receptacle terminal 820 of a remaining one of the two rows face orientations same as each other in the width direction. Referring to FIGS. 2 and 3, in neighboring two of the receptacle terminals 820 in the pitch direction, an orientation, which the support contact point 824 of one of the two receptacle terminals 820 faces in the width direction, is opposite to an orientation which the support contact point 824 of a remaining one of the two receptacle terminals 820 faces in the width direction.

As shown in FIG. 2, the resilient portion 826 of the present embodiment is, at least in part, resiliently deformable. The resilient portion 826 connects between the main contact point 828 and the support contact point 824. The resilient portion 826 extends from the main contact point 828 to the support contact point 824.

As shown in FIG. 2, each of the receptacle terminals 820 has a held portion 822, a connection portion 823, a mounting portion 825, a lock portion 827 and a supplemental lock portion 829.

As shown in FIG. 2, the held portion 822 of the present embodiment couples the connection portion 823 and the mounting portion 825 with each other. The held portion 822 extends downward in the up-down direction from the connection portion 823. The held portion 822 extends upward in the up-down direction from the mounting portion 825. The held portion 822 is held by the receptacle insulator 810. Specifically, the held portion 822 is embedded in the receptacle insulator 810.

As shown in FIG. 2, the connection portion 823 of the present embodiment connects the held portion 822 and the support contact point 824 with each other. The connection portion 823 extends from the held portion 822 in an orientation closer to the main contact point 828 in the width direction, and is bent so that it extends downward in the up-downward to the support contact point 824.

As shown in FIG. 2, the mounting portion 825 of the present embodiment is bent at a lower end of the held portion 822 and extends therefrom in an orientation away from the main contact point 828 in the width direction. The mounting portion 825 defines an end of the receptacle terminal 820 in the width direction. The mounting portion 825 defines a lower end of the receptacle terminal 820 in the up-down direction. The mounting portion 825 is soldered to the pad of the substrate when the receptacle connector 800 is mounted on the substrate.

As shown in FIG. 2, the lock portion 827 of the present embodiment is oblique to both the up-down direction and the width direction. The lock portion 827 is positioned below the support contact point 824 in the up-down direction. The lock portion 827 is positioned at a position same as a position of the main contact point 828 in the up-down direction.

As shown in FIG. 2, the supplemental lock portion 829 of the present embodiment is oblique to both the up-down direction and the width direction. The supplemental lock portion 829 is positioned below the main contact point 828 in the up-down direction. The supplemental lock portion 829 is positioned downward in the up-down direction beyond the support contact point 824. The supplemental lock portion 829 is positioned downward in the up-down direction beyond the lock portion 827.

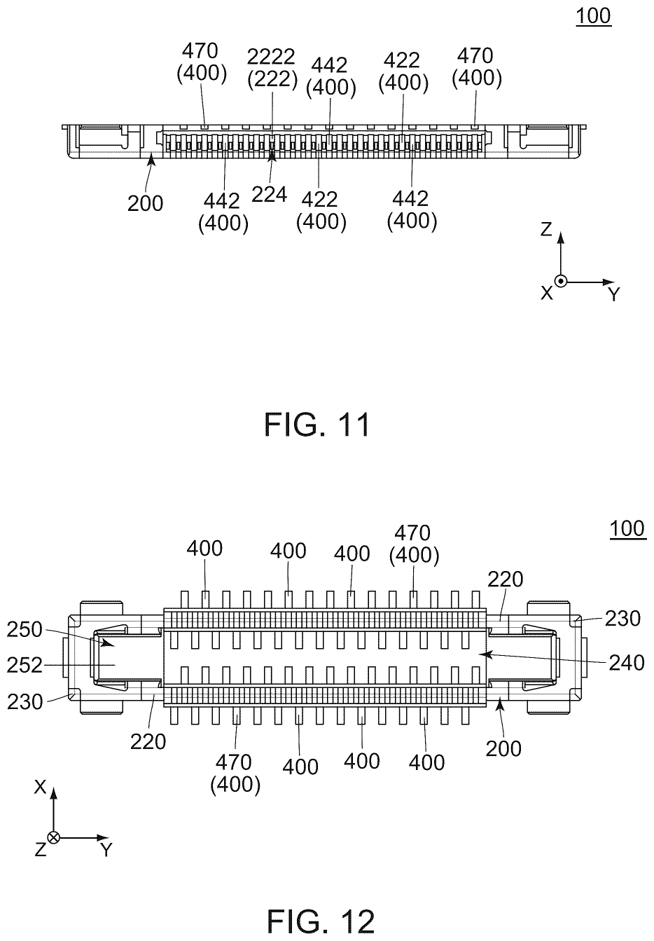

Referring to FIG. 11, the plug connector 100 of the present embodiment is mountable on a substrate (not shown) whose surface is formed with pads (not shown). As shown in FIG. 6, the plug connector 100 of the present embodiment is mateable with the receptacle connector 800 in the up-down direction.

As shown in FIG. 12, the plug connector 100 includes a plug insulator 200 and plug terminals 400.

Referring to FIG. 12, the plug insulator 200 of the present embodiment is made of insulator. The plug insulator 200 holds the plug terminals 400. The plug insulator 200 has two long wall portions 220, two short wall portions 230 and an island-like portion accommodating portion 250. However, the present invention is not limited thereto, but the number of the long wall portion 220 may be one.

As shown in FIG. 12, each of the long wall portions 220 of the present embodiment defines an outer end of the plug insulator 200 in the width direction. As shown in FIG. 8, each of the long wall portions 220 has a height in the up-down direction and extends in the pitch direction. Each of the long wall portions 220 couples the two short wall portions 230 with each other in the pitch direction. The two long wall portions 220 are arranged in the width direction. The long wall portions 220 are accommodated in the wall portion accommodating portion 812 when the plug connector 100 and the receptacle connector 800 are mated with each other.

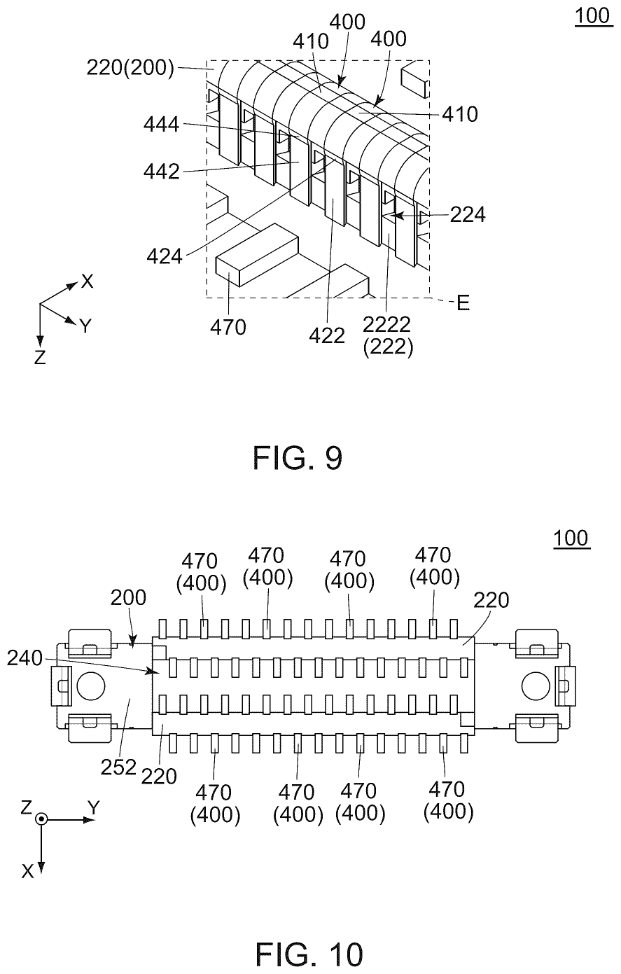

As shown in FIG. 9, each of the long wall portions 220 is formed with a plurality of interposing portions 222 and a plurality of holes 224.

As shown in FIG. 9, the interposing portions 222 of the present embodiment are arranged in the pitch direction. Each of the interposing portions 222 extends in the up-down direction. Each of the interposing portions 222 is positioned between adjacent two of the plug terminals 400 in the pitch direction. As shown in FIGS. 8 and 9, each of the interposing portions 222 has a first surface 2222 and a second surface 2224 in the width direction.

As shown in FIG. 11, the first surface 2222 of the present embodiment faces outward in the width direction. The first surface 2222 defines an outer end of the interposing portion 222 in the width direction. The first surface 2222 intersects with the width direction. More specifically, the first surface 2222 is perpendicular to the width direction. The first surface 2222 extends in the up-down direction.

As shown in FIG. 8, the second surface 2224 of the present embodiment faces inward in the width direction. The second surface 2224 defines an inner end of the interposing portion 222 in the width direction. The second surface 2224 intersects with the width direction. More specifically, the second surface 2224 is perpendicular to the width direction. The second surface 2224 extends in the up-down direction.

As shown in FIG. 9, the holes 224 of the present embodiment are arranged in the pitch direction. Each of the holes 224 pierces the long wall portion 220 in the width direction. Each of the holes 224 is positioned between adjacent two of the plug terminals 400 in the pitch direction. The hole 224 is positioned above the interposing portion 222 in the up-down direction. The holes 224 correspond to the interposing portions 222, respectively. Each of the holes 224 is positioned above the corresponding interposing portion 222 in the up-down direction.

As shown in FIG. 12, each of the short wall portions 230 of the present embodiment defines an outer end of the plug insulator 200 in the pitch direction. As shown in FIG. 8, each of the short wall portions 230 has a height in the up-down direction and extends in the width direction. Each of the short wall portions 230 couples the two long wall portions 220 with each other in the width direction. The short wall portions 230 are accommodated in the wall portion accommodating portion 812 when the plug connector 100 and the receptacle connector 800 are mated with each other.

Referring to FIG. 12, the island-like portion accommodating portion 250 of the present embodiment is a recess which is recessed upward in the up-down direction. Specifically, the island-like portion accommodating portion 250 has an upper surface 252. The upper surface 252 defines an upper end of the island-like portion accommodating portion 250. The island-like portion accommodating portion 250 accommodates the island-like portion 814 when the plug connector 100 and the receptacle connector 800 are mated with each other.

As shown in FIG. 10, the plug insulator 200 is formed with an opening 240.

As shown in FIG. 10, the opening 240 of the present embodiment pierces the upper surface 252 of the island-like portion accommodating portion 250 in the up-down direction. The opening 240 is positioned at an upper end of the plug insulator 200 in the up-down direction.

Referring to FIGS. 2 and 3, each of the plug terminals 400 of the present embodiment is made of metal. The plug terminals 400 have shapes same as each other. The plug terminals 400 are held by the plug insulator 200. Specifically, the plug terminals 400 are partially embedded in and held by the plug insulator 200 via insert-molding. The plug terminals 400 are held by the long wall portion 220. The plug terminals 400 are partially embedded in and held by the long wall portion 220. Two rows of the plug terminals 400 correspond to the two long wall portions 220, respectively. The plug terminals 400 of each row are held by the corresponding long wall portion 220. The plug terminals 400 of each row are partially embedded in and held by the corresponding long wall portion 220.

As shown in FIG. 12, the plug terminals 400 of the present embodiment are arranged in the pitch direction. More in detail, the plug terminals 400 are arranged in the two rows, namely, a front row and a rear row, in the width direction. However, the present invention is not limited thereto. Specifically, the plug terminals 400 may be arranged in a row. In other words, the plug connector 100 should have a row of the plug terminals 400. The plug terminals 400 of one of the two rows correspond to the plug terminals 400, respectively, of a remaining one of the two rows. The plug terminals 400 of each row are arranged in the pitch direction. The plug terminals 400 are staggered in arrangement. More specifically, in each row, the plug terminals 400 are staggered in arrangement.

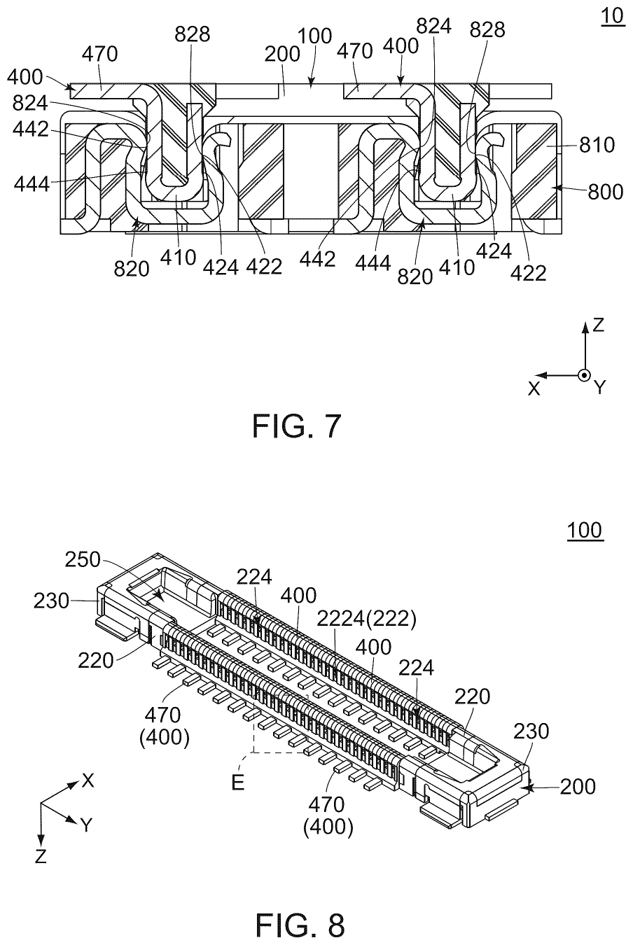

Referring to FIGS. 2 and 3, the receptacle terminals 820 correspond to the plug terminals 400, respectively. As shown in FIGS. 6 and 7, under a mated state where the plug connector 100 is mated with the receptacle connector 800, the receptacle terminals 820 are in contact with the plug terminals 400, respectively.

As shown in FIG. 2, each of the plug terminals 400 has a main contact portion 422, a support contact portion 442, an insertion end portion 410, a contact difference 444 and an additional contact difference 424.

As shown in FIG. 2, the main contact portion 422 of the present embodiment intersects with the width direction. More specifically, the main contact portion 422 is perpendicular to the width direction. The main contact portion 422 of the plug terminal 400 of one of the two rows and the main contact portion 422 of the corresponding plug terminal 400 of a remaining one of the two rows face orientations same as each other in the width direction. Referring to FIGS. 2 and 3, in neighboring two of the plug terminals 400 in the pitch direction, an orientation, which the main contact portion 422 of one of the two plug terminals 400 faces in the width direction, is opposite to an orientation which the main contact portion 422 of a remaining one of the two plug terminals 400 faces in the width direction.

As shown in FIG. 2, the support contact portion 442 of the present embodiment intersects with the width direction. More specifically, the support contact portion 442 is perpendicular to the width direction. For each of the plug terminals 400, the main contact portion 422 and the support contact portion 442 are apart from each other in the width direction. For each of the plug terminals 400, a part of the insertion end portion 410 is larger than a minimum distance Dm between the main contact portion 422 and the support contact portion 442 in the width direction. The support contact portion 442 of the plug terminal 400 of one of the two rows and the support contact portion 442 of the corresponding plug terminal 400 of a remaining one of the two rows face orientations same as each other in the width direction. Referring to FIGS. 2 and 3, in neighboring two of the plug terminals 400 in the pitch direction, an orientation, which the support contact portion 442 of one of the two plug terminals 400 faces in the width direction, is opposite to an orientation which the support contact portion 442 of a remaining one of the two plug terminals 400 faces in the width direction.

Referring to FIGS. 6 and 7, the insertion end portion 410 of each of the plug terminals 400 is inserted between the main contact point 828 and the support contact point 824 of the receptacle terminal 820 corresponding thereto, when the plug connector 100 is mated with the receptacle connector 800. Under the mated state where the plug connector 100 and the receptacle connector 800 are mated with each other, the main contact points 828 are in contact with the main contact portions 422 while the support contact points 824 are in contact with the support contact portions 442.

Referring to FIG. 9, the main contact portion 422 of each of the plug terminals 400 is flush with the support contact portion 442 of the plug terminal 400 adjacent thereto. More in detail, in neighboring two of the plug terminals 400 in the pitch direction, the main contact portion 422 of one of the two plug terminals 400 is flush with the support contact portion 442 of a remaining one of the two plug terminals 400 while the support contact portion 442 of the one of the two plug terminals 400 is flush with the main contact portion 422 of the remaining one of the two plug terminals 400. This enables a metal mold, which is used upon the insert-molding of the plug connector 100 of the connector assembly 10 of the present embodiment, to have a simple planar surface by which a manufacturer is configured to simultaneously press the main contact portion 422 and the support contact portion 442. Accordingly, the metal mold can have a simple shape. In other words, the connector assembly 10 of the present embodiment can have a reduced manufacturing cost.

Referring to FIG. 9, the insertion end portion 410 of the present embodiment has a U-like shape. Specifically, the insertion end portion 410 has the U-like shape when the plug terminal 400 is viewed along the pitch direction. The insertion end portion 410 defines a lower end of the plug terminal 400 in the up-down direction.

Referring to FIG. 9, the contact difference 444 of the present embodiment is formed by bending a part of the plug terminal 400. In other words, each of the plug terminals 400 has a bent portion 444 of the contact difference 444. The contact difference 444 is positioned at a boundary between the insertion end portion 410 and the support contact portion 442. The contact difference 444 is positioned above the insertion end portion 410 in the up-down direction. The support contact portion 442 is positioned above the contact difference 444 in the up-down direction. The contact difference 444 extends across the whole of the plug terminal 400 in the pitch direction.

Referring to FIGS. 2 and 6, when a user mates the plug connector 100 with the receptacle connector 800, the support contact point 824 of each of the receptacle terminals 820 of the receptacle connector 800 rides over the contact difference 444 of the corresponding plug terminal 400 and is moved upward. This enables the user to get a click feeling or tactile signal. In other words, the connector assembly 10 of the present embodiment is configured so that a user can get a click feeling or tactile signal when the plug connector 100 and the receptacle connector 800 are mated with each other.

In particular, the plug terminal 400 of the present embodiment is, as described above, provided with the contact difference 444 which is formed by bending the part of the plug terminal 400 and which extends across the whole of the plug terminal 400 in the pitch direction. Accordingly, the connector assembly 10 of the present embodiment is configured so that the support contact point 824 of the receptacle terminal 820 can always ride over the contact difference 444 of the corresponding plug terminal 400 even in a case where the plug terminal 400 is deviated in the pitch direction with respect to the corresponding receptacle terminal 820 when the receptacle connector 800 is mated with the plug connector 100 whose plug terminals 400 have small sizes in the pitch direction. Thus, the connector assembly 10 of the present embodiment is configured so that a user can reliably get a click feeling or tactile signal even in this case.

Referring to FIG. 2, the contact difference 444 and the lock portion 827 lock the mating of the plug connector 100 with the receptacle connector 800 when the plug connector 100 and the receptacle connector 800 are mated with each other.

Referring to FIG. 9, the additional contact difference 424 of the present embodiment is formed by bending a part of the plug terminal 400. In other words, each of the plug terminals 400 has another bent portion 424 of the additional contact difference 424. The additional contact difference 424 is positioned at a boundary between the insertion end portion 410 and the main contact portion 422. The additional contact difference 424 is positioned above the insertion end portion 410 in the up-down direction. The main contact portion 422 is positioned above the additional contact difference 424 in the up-down direction. The additional contact difference 424 extends across the whole of the plug terminal 400 in the pitch direction.

As described above, the plug terminal 400 is provided with the contact difference 444 which is for producing a click feeling or tactile signal and locking the aforementioned mating. Additionally, the plug terminal 400 is further provided with the additional contact difference 424. Accordingly, in each row in which the plug terminals 400 are staggered in arrangement, the main contact portion 422, which is positioned above the additional contact difference 424 of each of the plug terminals 400, can be flush with the support contact portion 442 which is positioned above the contact difference 444 of the plug terminal 400 adjacent thereto.

Referring to FIGS. 2 and 6, when a user mates the plug connector 100 with the receptacle connector 800, the main contact point 828 of each of the receptacle terminals 820 of the receptacle connector 800 rides over the additional contact difference 424 and is moved upward.

Referring to FIGS. 2 and 6, when the plug connector 100 and the receptacle connector 800 are mated with each other, the additional contact difference 424 and the supplemental lock portion 829 supplementally lock the aforementioned mating.

As shown in FIG. 2, the plug terminal 400 has a mounting portion 470.

As shown in FIG. 2, the mounting portion 470 of the present embodiment extends from the support contact portion 442. Specifically, the mounting portion 470 is bent at an end of the support contact portion 442 so that it extends therefrom in an orientation away from the main contact portion 422 in the width direction. The mounting portion 470 defines an end of the plug terminal 400 in the width direction. The mounting portion 470 defines an upper end of the plug terminal 400 in the up-down direction. Referring to FIG. 11, the mounting portion 470 is soldered to the pad of the substrate when the plug connector 100 is mounted on the substrate.

Where the present embodiment of the present invention is described above, the present embodiment may be modified as follows.

### (First Modification)

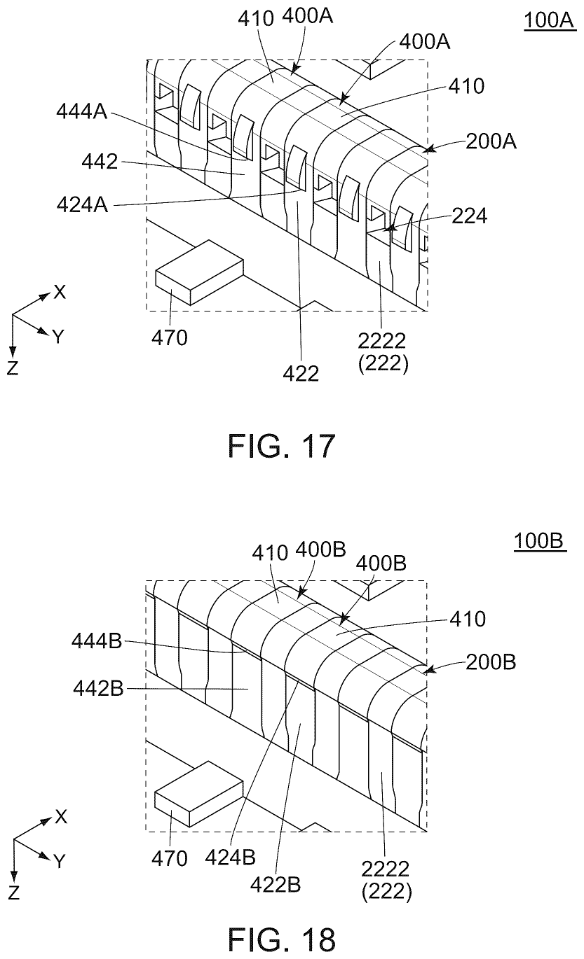

Referring to FIG. 17, a connector assembly (not shown) according to a first modification comprises a plug connector 100A and a receptacle connector (not shown). The receptacle connector of the present modification has a configuration same as that of the receptacle connector 800 of the aforementioned embodiment. Accordingly, a detailed description thereabout is omitted.

As shown in FIG. 17, the plug connector 100A of the present modification includes a plug insulator 200A and plug terminals 400A. The plug insulator 200A of the present modification has a configuration same as that of the plug insulator 200 of the aforementioned embodiment. Accordingly, a detailed description thereabout is omitted.

As shown in FIG. 17, each of the plug terminals 400A of the present modification has a main contact portion 422, a support contact portion 442, an insertion end portion 410, a contact difference 444A and an additional contact difference 424A. The main contact portion 422, the support contact portion 442 and the insertion end portion 410 of the present modification have configurations same as those of the main contact portion 422, the support contact portion 442 and the insertion end portion 410 of the aforementioned embodiment. Accordingly, a detailed description thereabout is omitted.

As shown in FIG. 17, the contact difference 444A of the present modification is positioned at a boundary between the insertion end portion 410 and the support contact portion 442. The contact difference 444A is positioned above the insertion end portion 410 in the up-down direction. The support contact portion 442 is positioned above the contact difference 444A in the up-down direction. The contact difference 444A is a dowel 444A protruding in the width direction. Specifically, the plug terminal 400A of the present modification is formed with the contact difference 444A by being provided with the dowel 444A. In other words, each of the plug terminals 400A has the dowel 444A which forms the contact difference 444A. Accordingly, similar to the connector assembly 10 of the aforementioned embodiment, the connector assembly of the present modification is also configured so that a support contact point (not shown) of a receptacle terminal (not shown) can always ride over the contact difference 444A of a corresponding one of the plug terminals 400A even in a case where the plug terminal 400A is deviated in the pitch direction with respect to the corresponding receptacle terminal when the receptacle connector is mated with the plug connector 100A whose plug terminals 400A have small sizes in the pitch direction. Thus, the connector assembly of the present modification is also configured so that a user can reliably get a click feeling or tactile signal even in this case. However, the present invention is not limited thereto, but the contact difference 444A may be a projection protruding in the width direction.

As shown in FIG. 17, the additional contact difference 424A of the present modification is positioned at a boundary between the insertion end portion 410 and the main contact portion 422. The additional contact difference 424A is positioned above the insertion end portion 410 in the up-down direction. The main contact portion 422 is positioned above the additional contact difference 424A in the up-down direction. The additional contact difference 424A is a dowel 424A protruding in the width direction. Specifically, the plug terminal 400A of the present modification is formed with the additional contact difference 424A by being provided with the dowel 424A. In other words, each of the plug terminals 400A has the dowel 424A which forms the additional contact difference 424A. However, the present invention is not limited thereto, but the additional contact difference 424A may be a projection protruding in the width direction.

### (Second Modification)

Referring to FIG. 18, a connector assembly (not shown) according to a second modification comprises a plug connector 100B and a receptacle connector (not shown). The receptacle connector of the present modification has a configuration same as that of the receptacle connector 800 of the aforementioned embodiment. Accordingly, a detailed description thereabout is omitted.

As shown in FIG. 18, the plug connector 100B of the present modification includes a plug insulator 200B and plug terminals 400B. The plug insulator 200B of the present modification has a configuration similar to that of the plug insulator 200 of the aforementioned embodiment except that the plug insulator 200B has no hole 224. Accordingly, a detailed description thereabout is omitted.

As shown in FIG. 18, each of the plug terminals 400B of the present modification has a main contact portion 422B, a support contact portion 442B, an insertion end portion 410, a contact difference 444B and an additional contact difference 424B. The insertion end portion 410 of the present modification have a configuration same as that of the insertion end portion 410 of the aforementioned embodiment. Accordingly, a detailed description thereabout is omitted.

Referring to FIG. 18, the main contact portion 422B of the present modification intersects with the width direction. More specifically, the main contact portion 422B is perpendicular to the width direction. The main contact portion 422B of the plug terminal 400B of one of two rows and the main contact portion 422B of a corresponding one of the plug terminals 400 of a remaining one of the two rows face orientations same as each other in the width direction. In neighboring two of the plug terminals 400B in the pitch direction, an orientation, which the main contact portion 422B of one of the two plug terminals 400B faces in the width direction, is opposite to an orientation which the main contact portion 422B of a remaining one of the two plug terminals 400B faces in the width direction.

Referring to FIG. 18, the support contact portion 442B of the present modification intersects with the width direction. More specifically, the support contact portion 442B is perpendicular to the width direction. For each of the plug terminals 400B, the main contact portion 422B and the support contact portion 442B are apart from each other in the width direction. For each of the plug terminals 400B, a part of the insertion end portion 410 is larger than a minimum distance between the main contact portion 422B and the support contact portion 442B in the width direction. The support contact portion 442B of the plug terminal 400B of one of the two rows and the support contact portion 442B of the corresponding plug terminal 400B of a remaining one of the two rows face orientations same as each other in the width direction. In neighboring two of the plug terminals 400B in the pitch direction, an orientation, which the support contact portion 442B of one of the two plug terminals 400B faces in the width direction, is opposite to an orientation which the support contact portion 442B of a remaining one of the two plug terminals 400B faces in the width direction.

Referring to FIG. 18, the main contact portion 422B of each of the plug terminals 400B is flush with the support contact portion 442B of the plug terminal 400B adjacent thereto. More in detail, in neighboring two of the plug terminals 400B in the pitch direction, the main contact portion 422B of one of the two plug terminals 400B is flush with the support contact portion 442B of a remaining one of the two plug terminals 400B while the support contact portion 442B of the one of the two plug terminals 400B is flush with the main contact portion 422B of the remaining one of the two plug terminals 400B. Similar to the connector assembly 10 of the aforementioned embodiment, this also enables a metal mold, which is used upon insert-molding of the plug connector 100B of the connector assembly of the present modification, to have a simple planar surface by which a manufacturer is configured to simultaneously press the main contact portion 422B and the support contact portion 442B. Accordingly, the metal mold can also have a simple shape. In other words, the connector assembly of the present modification can also have a reduced manufacturing cost.

Referring to FIG. 18, each of the main contact portion 422B and the support contact portion 442B of the present modification is formed by coining. Specifically, in each of the plug terminals 400B, every of the main contact portion 422B and the support contact portion 442B is thinner than the insertion end portion 410.

Referring to FIG. 18, the contact difference 444B of the present modification is formed together with the formation of the support contact portion 442B by coining. The contact difference 444B is positioned at a boundary between the insertion end portion 410 and the support contact portion 442B. The contact difference 444B is positioned above the insertion end portion 410 in the up-down direction. The support contact portion 442B is positioned above the contact difference 444B in the up-down direction. The contact difference 444B extends across the whole of the plug terminal 400B in the pitch direction. Accordingly, similar to the connector assembly 10 of the aforementioned embodiment, the connector assembly of the present modification is also configured so that a support contact point (not shown) of a receptacle terminal (not shown) can always ride over the contact difference 444B of a corresponding one of the plug terminals 400B even in a case where the plug terminal 400B is deviated in the pitch direction with respect to the corresponding receptacle terminal when the receptacle connector is mated with the plug connector 100B whose plug terminals 400B have small sizes in the pitch direction. Thus, the connector assembly of the present modification is also configured so that a user can reliably get a click feeling or tactile signal even in this case.

Referring to FIG. 18, the additional contact difference 424B of the present modification is formed together with the formation of the main contact portion 422B by coining. The additional contact difference 424B is positioned at a boundary between the insertion end portion 410 and the main contact portion 422B. The additional contact difference 424B is positioned above the insertion end portion 410 in the up-down direction. The main contact portion 422B is positioned above the additional contact difference 424B in the up-down direction. The additional contact difference 424B extends across the whole of the plug terminal 400B in the pitch direction.

### (Third Modification)

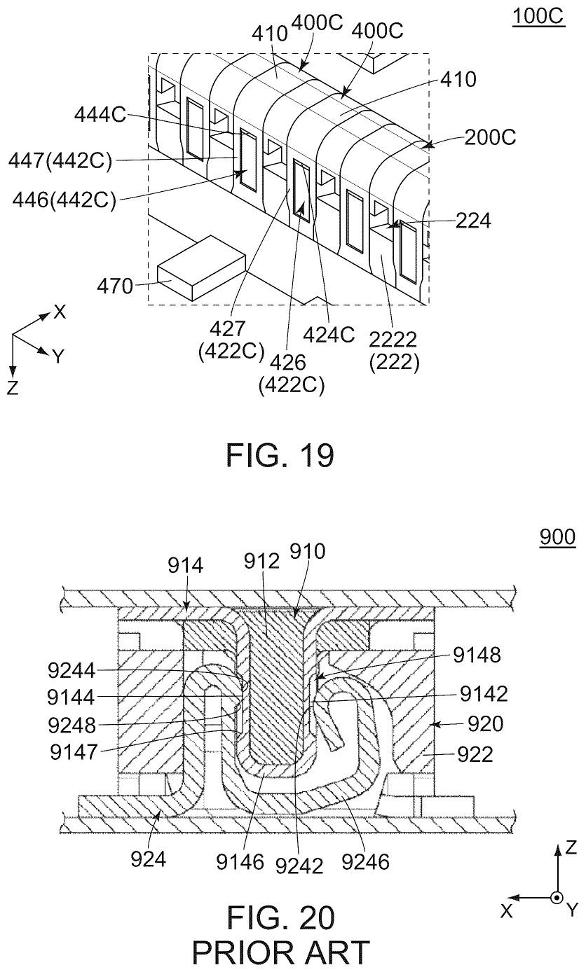

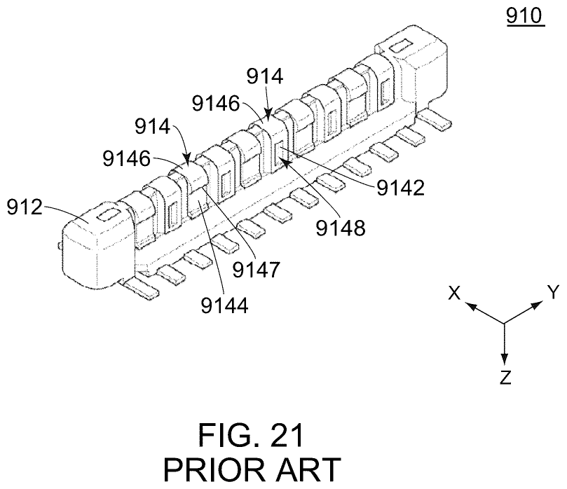

Referring to FIG. 19, a connector assembly (not shown) according to a third modification comprises a plug connector 100C and a receptacle connector (not shown). The receptacle connector of the present modification has a configuration same as that of the receptacle connector 800 of the aforementioned embodiment. Accordingly, a detailed description thereabout is omitted.

As shown in FIG. 19, the plug connector 100C of the present modification includes a plug insulator 200C and plug terminals 400C. The plug insulator 200C of the present modification has a configuration similar to that of the plug insulator 200 of the aforementioned embodiment. Accordingly, a detailed description thereabout is omitted.

As shown in FIG. 19, each of the plug terminals 400C of the present modification has a main contact portion 422C, a support contact portion 442C, an insertion end portion 410, a contact difference 444C and an additional contact difference 424C. The insertion end portion 410 of the present modification have a configuration same as that of the insertion end portion 410 of the aforementioned embodiment. Accordingly, a detailed description thereabout is omitted.

As shown in FIG. 19, in each of the plug terminals 400C, the main contact portion 422C is formed with a recess 426. In other words, the plug terminal 400C of the present modification has the main contact portion 422C which is partially recessed.

Referring to FIG. 19, the recess 426 of the present modification is formed by coining. The recess 426 is recessed in an orientation closer to the support contact portion 442C in the width direction. The recess 426 of the plug terminal 400C of one of two rows and the recess 426 of a corresponding one of the plug terminals 400C of a remaining one of the two rows face orientations same as each other in the width direction. In neighboring two of the plug terminals 400C in the pitch direction, an orientation, which the recess 426 of one of the two plug terminals 400C is recessed in the width direction, is opposite to an orientation which the recess 426 of a remaining one of the two plug terminals 400C is recessed in the width direction.

As shown in FIG. 19, the main contact portion 422C has an outermost main surface 427 adjacent to the recess 426.

Referring to FIG. 19, the outermost main surface 427 of the present modification surrounds the recess 426 corresponding thereto. The outermost main surface 427 intersects with the width direction. More in detail, the outermost main surface 427 is perpendicular to the width direction. The outermost main surface 427 of the plug terminal 400C of one of the two rows and the outermost main surface 427 of the corresponding plug terminal 400C of a remaining one of the two rows face orientations same as each other in the width direction. In neighboring two of the plug terminals 400C in the pitch direction, an orientation, which the outermost main surface 427 of one of the two plug terminals 400C faces in the width direction, is opposite to an orientation which the outermost main surface 427 of a remaining one of the two plug terminals 400C faces in the width direction.

As shown in FIG. 19, in each of the plug terminals 400C of the present modification, the support contact portion 442C is formed with another recess 446. In other words, the plug terminal 400C of the present modification has the support contact portion 442C which is partially recessed.

Referring to FIG. 19, the recess 446 of the present modification is formed by coining a part of the plug terminal 400C. The recess 446 is recessed in an orientation closer to the main contact portion 422C in the width direction. The recess 446 of the plug terminal 400C of one of the two rows and the recess 446 of the corresponding plug terminal 400C of a remaining one of the two rows face orientations same as each other in the width direction. In neighboring two of the plug terminals 400C in the pitch direction, an orientation, which the recess 446 of one of the two plug terminals 400C is recessed in the width direction, is opposite to an orientation which the recess 446 of a remaining one of the two plug terminals 400C is recessed in the width direction.

As shown in FIG. 19, the support contact portion 442C has an outermost support surface 447 adjacent to the recess 446.

Referring to FIG. 19, the outermost support surface 447 of the present modification surrounds the recess 446 corresponding thereto. The outermost support surface 447 intersects with the width direction. More in detail, the outermost support surface 447 is perpendicular to the width direction. The outermost support surface 447 of the plug terminal 400C of one of the two rows and the outermost support surface 447 of the corresponding plug terminal 400C of a remaining one of the two rows face orientations same as each other in the width direction. In neighboring two of the plug terminals 400C in the pitch direction, an orientation, which the outermost support surface 447 of one of the two plug terminals 400C faces in the width direction, is opposite to an orientation which the outermost support surface 447 of a remaining one of the two plug terminals 400C faces in the width direction.

As shown in FIG. 19, the outermost main surface 427 of each of the plug terminals 400C is flush with the outermost support surface 447 of the plug terminal 400C adjacent thereto. More in detail, in neighboring two of the plug terminals 400C in the pitch direction, the outermost main surface 427 of one of the two plug terminals 400C is flush with the outermost support surface 447 of a remaining one of the two plug terminals 400C while the outermost support surface 447 of the one of the two plug terminals 400C is flush with the outermost main surface 427 of the remaining one of the two plug terminals 400C. In other words, the main contact portion 422C of each of the plug terminals 400C is flush with the support contact portion 442C of the plug terminal 400C adjacent thereto. Similar to the connector assembly 10 of the aforementioned embodiment, this also enables a metal mold, which is used upon insert-molding of the plug connector 100C of the connector assembly of the present modification, to have a simple planar surface by which a manufacturer is configured to simultaneously press the main contact portion 422C and the support contact portion 442C. Accordingly, the metal mold can also have a simple shape. In other words, the connector assembly of the present embodiment can also have a reduced manufacturing cost.

As shown in FIG. 19, the contact difference 444C of the present modification is formed together with the formation of the recess 446 by coining. The contact difference 444C is positioned at a boundary between the insertion end portion 410 and the recess 446 of the support contact portion 442C.

As shown in FIG. 19, the additional contact difference 424C of the present modification is formed together with the formation of the recess 426 by coining. The additional contact difference 424C is positioned at a boundary between the insertion end portion 410 and the recess 426 of the main contact portion 422C.

In the connector assembly of the present modification, as a size of the plug terminal 400C in the pitch direction decreases, a size of the recess 446 in the pitch direction decreases so that a size of the contact difference 444C in the pitch direction decreases. Based on the above, a support contact point (not shown) of a receptacle terminal (not shown) may not be snapped into the recess 446 of a corresponding one of the plug terminals 400 in a case where the plug terminal 400C is deviated in the pitch direction with respect to the corresponding receptacle terminal when the plug connector 100C and the receptacle connector of the present modification are mated with each other. That is, in this case, there is concern that the support contact point of the receptacle terminal may not ride over the contact difference 444C so that a click feeling or tactile signal may not be produced.

In contrast, no such concern exists with the connector assemblies 10 of the aforementioned embodiment, the first modification and the second modification which comprise the plug terminals 400, 400A, 400B with the contact differences 444, 444A, 444B. That is, the connector assemblies 10 of the aforementioned embodiment, the first modification and the second modification are configured so that the support contact point 824 of the receptacle terminal 820 can always ride over the contact difference 444, 444A, 444B of the corresponding plug terminal 400, 400A, 400B even in the case where the plug terminal 400, 400A, 400B is deviated in the pitch direction with respect to the corresponding receptacle terminal 820 when the receptacle connector 800 is mated with the plug connector 100, 100A, 100B whose plug terminals 400, 400A, 400B have small sizes in the pitch direction. Thus, the connector assemblies 10 of the aforementioned embodiment, the first modification and the second modification are configured so that a user can reliably get a click feeling or tactile signal even in this case. Consequently, the connector assemblies 10 of the aforementioned embodiment, the first modification and the second modification are more preferable.

Although the specific explanation about the present invention is made above referring to the embodiments, the present invention is not limited thereto and is susceptible to various modifications and alternative forms.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector assembly comprising a plug connector and a receptacle connector which are mateable with each other, wherein:
the receptacle connector includes a receptacle insulator and a row of receptacle terminals held by the receptacle insulator;
the receptacle terminals are staggered in arrangement;
each of the receptacle terminals has a main contact point, a support contact point, and a resilient portion, wherein the resilient portion connects between the support contact point and the main contact point;
for each of the receptacle terminals, the main contact point and the support contact point are apart from each other in a width direction;
the plug connector includes a plug insulator and a row of plug terminals held by the plug insulator;
the plug terminals are staggered in arrangement;
each of the plug terminals has a main contact portion, a support contact portion, an insertion end portion, a contact difference and an additional contact difference;
for each of the plug terminals, the main contact portion and the support contact portion are apart from each other in the width direction;
for each of the plug terminals, a part of the insertion end portion is larger than a minimum distance between the main contact portion and the support contact portion in the width direction;
the contact difference is positioned at a boundary between the insertion end portion and the support contact portion;
the additional contact difference is positioned at a boundary between the insertion end portion and the main contact portion;
the receptacle terminals correspond to the plug terminals, respectively;
the insertion end portion of each of the plug terminals is inserted between the main contact point and the support contact point of the receptacle terminal corresponding thereto, when the plug connector is mated with the receptacle connector;
under a mated state where the plug connector and the receptacle connector are mated with each other, the main contact points are in contact with the main contact portions while the support contact points are in contact with the support contact portions; and
the main contact portion of each of the plug terminals is flush with the support contact portion of the plug terminal adjacent thereto.

2. The connector assembly according to claim 1, wherein each of the plug terminals has a bent portion of the contact difference and another bent portion of the additional contact difference.

3. The connector assembly according to claim 1, wherein each of the plug terminals has a dowel, which forms the contact difference, and another dowel which forms the additional contact difference.

4. The connector assembly according to claim 1, wherein, in each of the plug terminals, every of the main contact portion and the support contact portion is thinner than the insertion end portion.

5. The connector assembly according to claim 1, wherein:
in each of the plug terminals, the main contact portion is formed with a recess while the support contact portion is formed with another recess; and
the additional contact difference is formed at a boundary between the insertion end portion and the recess of the main contact portion, while the contact difference is formed at a boundary between the insertion end portion and the recess of the support contact portion.
